(19) United States
(12) Patent Application Publication
(10) Pub. No.: US 2009/0229886 A1
(43) Pub. Date: Sep. 17, 2009

(54) Non-Grease Type Bearing Lubricant

(75) Inventor: Terry J. Koltermann, The Woodlands, TX (US)

Correspondence Address: Bracewell & Giuliani LLP, P.O. Box 61389, Houston, TX, 77208-1389, US

(73) Assignee: Baker Hughes Incorporated, Houston, TX (US)

(21) Appl. No.: 12/402,198

(22) Filed: Mar. 11, 2009

Related U.S. Application Data
(60) Provisional application No. 61/035,656, filed on Mar. 11, 2008.

(51) Int. Cl. E21B 10/24; F16C 33/66

(52) U.S. Cl. 175/372; 175/371; 384/93

(57) ABSTRACT

The present disclosure includes a lubricant for use in a roller cone rock bit, where the lubricant comprises a non-grease formulation. The lubricant can comprise synthetic lubricating fluids and combinations thereof as well as combinations of synthetic fluid or fluids with mineral oil or oils. The lubricant can contain one or more additional ingredients and have a minimum viscosity of 100 centistokes at 212° F. The additional ingredients include fluid soluble or dispersed extreme pressure and antiwear additives, and solid lubricants.

### RELATED APPLICATIONS

This application claims priority to and the benefit of co-pending U.S. Provisional Application Ser. No. 61/035,656, filed Mar. 11, 2008, the full disclosure of which is hereby incorporated by reference herein.

### BACKGROUND

1. Field of Invention

The present disclosure relates to a lubricant for use in an earth boring bit. More specifically, the present disclosure concerns an earth boring bit having a non-grease composition lubricant.

2. Description of Prior Art

There is a continuing need to develop functional fluids capable of serving as lubricant compositions in extreme temperature and pressure environments. Such an example environment is that of bits used to drill subterranean formations.

Rock bits of the rolling element and journal bearing types are employed for drilling such subterranean formations in order to produce oil, gas, geothermal steam and other fluids. Such bits have a body with a threaded upper extent which is connected within a drill string leading to the surface and have several, typically three, cutter cones which are mounted on pins integral with the body of the bit at its lower end.

In use, the drill string and bit body are rotated within the borehole and each cone is caused to rotate on its respective pin as the cone contacts the bottom of the borehole to disintegrate earthen formations. As the rock bit begins to penetrate hard, tough earthen formations, high pressures and temperatures are encountered. Typical drilling operations thus take place in an abrasive atmosphere of drilling mud and rock particles which are thousands of feet from the engineer or supervisor, who does not typically have the benefit of oil pressure gauges or temperature sensors at the surfaces.

Lubricants used in the bearing regions of such rock bits are thus a critical element of the life of the rock bit. The grease utilized to lubricate a rock bit of this type can encounter temperatures above 300° F., thereby subjecting the lubrication system to severe and demanding constraints. The lubricant must not break down under the temperature and pressure conditions encountered, must not generate substantial internal pressures in the bit, and must enable flow through passages to the surfaces to be lubricated. Per ASTM standard D217-02 Section 3, lubricating grease is a semi-fluid to solid product of a dispersion of a thickener in a liquid lubricant.

Failure of the lubrication system quickly results in failure of the rock bit as a whole. When the rock bit wears out or fails as the borehole is being drilled, it is necessary to withdraw the drill string for replacing the bit. The amount of time required to make a round trip for replacing a bit is essentially lost from drilling operations. This time can become a significant portion of the total time for completing a well, particularly as the well depths become greater and greater. A successful lubricant should have a useful life longer than other elements of the rock bit so that premature failures of bearings do not unduly limit drilling.

A variety of lubricants have been employed in rock bits in the past which typically comprise a high viscosity. The lubricants typically comprise refined petroleum (hydrocarbon) oil or mineral oil, which provides the basic lubricity of the composition and may constitute about 75% of the total composition. Grease is formed by adding a thickening agent to the mineral oil or by forming the thickening agent in the mineral oil via a chemical reaction. Example thickening agents include solid materials, e.g. treated clays or pigments and metal soaps (metal salts of organic acids). Typical metal soap types include aluminum, barium, calcium, lithium, sodium, or strontium. Soaps are produced from organic acids some of which are derived from animal or vegetable sources reacted with alkali metal hydroxides, i.e. aluminum, calcium, sodium, or lithium hydroxide. More than one organic acid may be reacted with an alkaline metal hydroxide forming what is termed complex soap. All known roller cone rock bit lubricants comprise a form of grease.

### SUMMARY OF INVENTION

Disclosed is an earth-boring bit having a bit body, a cantilevered shaft depending from the bit body, a conically shaped cutter rotatably mounted on the shaft, bearing surfaces on the shaft and the conical cutter, and a non-grease type lubricant comprising a synthetic fluid on the bearing surfaces. A friction bearing or antifriction bearing can be included. The synthetic fluid can be polyalphaolefin, a polyolester, a polyalkylene glycol combinations of polyalphaolefin, polyolester, and polyalkylene glycols, hydrocarbon fluids, esters, polyethers, alkylene oxide polymers, esters of phosphorus, silicon based fluid, fluorinated polyethers, and combinations thereof. In an embodiment, the lubricant has at least about 51% by volume of synthetic fluid. The lubricant can include a solid such as, molybdenum disulfide, tungsten disulfide, graphite, calcium fluoride, zinc oxide, or combinations thereof. The lubricant viscosity can be at least 100 centistokes at 212° F. In one example, the lubricant is free of a thickening agent.

### BRIEF DESCRIPTION OF DRAWINGS

Some of the features and benefits of the present invention having been stated, others will become apparent as the description proceeds when taken in conjunction with the accompanying drawings, in which:

FIG. 1 is a partial cut-away view of a rotary cone bit illustrating the lubricant disposed therein.

FIG. 2 is a sectional view of a bearing assembly for use with a rotary cone bit.

FIG. 3 is a partial sectional view of a bearing assembly for use with a rotary cone bit.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The present invention will now be described more fully hereinafter with reference to the accompanying drawings in which embodiments of the invention are shown. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art. Like numbers refer to like elements throughout.

It is to be understood that the invention is not limited to the exact details of construction, operation, exact materials, or embodiments shown and described, as modifications and equivalents will be apparent to one skilled in the art. In the drawings and specification, there have been disclosed illustrative embodiments of the invention and, although specific terms are employed, they are used in a generic and descriptive sense only and not for the purpose of limitation. Accordingly, the invention is therefore to be limited only by the scope of the appended claims.

In one embodiment a roller cone rock bit lubricant comprises a synthetic fluid having the requisite viscosity suitable for use within a roller cone. By requisite viscosity it is meant that the lubricant has sufficient viscosity to maintain a lubricating film between opposing moving parts in a roller cone bit during use of the bit. High loads on the bearings combined with high operating temperatures during rock bit use require a lubricant having a high viscosity. Downhole temperatures often exceed 200° F. A fully formulated fluid of an embodiment would have a minimum viscosity of 100 centistokes at 212° F.

Examples of synthetic fluids that may be employed as a lubricant include synthetic hydrocarbon fluids (e.g. polyalphaolefin) polyol esters, synthetic polyethers, alkylene oxide polymers, esters of phosphorus, silicon based fluid, fluorinated polyethers and combinations thereof. The bit lubricant as described herein does not have thickeners and therefore is a non-grease or greaseless lubricant. The above represents but a partial list of the synthetic fluids that may be employed. Additionally combinations of mineral oils(s) and synthetic fluids(s) such as those listed above may be employed.

Optionally the lubricant may include solid lubricants such as molybdenum disulfide, tungsten disulfide, graphite, calcium fluoride and zinc oxide. Fluid soluble extreme pressure and antiwear additives may also be included.

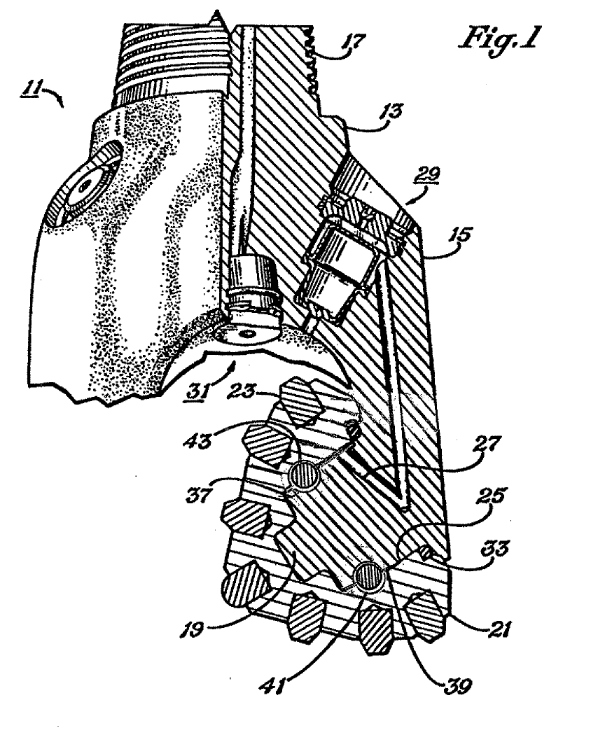

FIG. 1 shows portions of an earth boring drill bit 11 of a type that can be used with the lubricant herein disclosed. The bit 11 includes a body 13 formed of three head sections 15 typically joined by a welding process. Threads 17 are formed on the top of the body 13 for connection to a conventional drill string, not shown. Each head section 15 has a cantilevered shaft or bearing pin 19 having its unsupported end oriented inward and downwardly. A generally conically shaped cutter 21 is rotatably mounted on each bearing pin 19. The cutter 21 has earth disintegrating teeth 23 on its exterior and a central opening or bearing recess 25 in its interior for mounting on the bearing pin 19. A nozzle 31 for discharging drilling fluid is shown facing downward from the bit body 13 towards the cone 21.

An O-ring seal 33 can be located between the bearing pin 19 and cutter 21 at the base of the bearing pin in a seal region. The O-ring 33 and seal region at the base of the bearing pin 19 prevent egress of lubricant and ingress of borehole fluid. Although an o-ring type seal is shown other types of seals may be employed. An annular assembly groove 37 is formed on the cylindrical surface 39 of the bearing pin 19. A groove 37 on the bearing pin 19 outer circumference is positioned to register with a groove 41 provided on the cutter cone 21 inner surface. When registered, the grooves 37, 41 form an annular cavity shown having a locking element 43 to retain cone 21 on bearing pin 19 but still allow rotation. In this embodiment, locking element 43 comprises a plurality of balls, but it could alternatively comprise a snap ring.

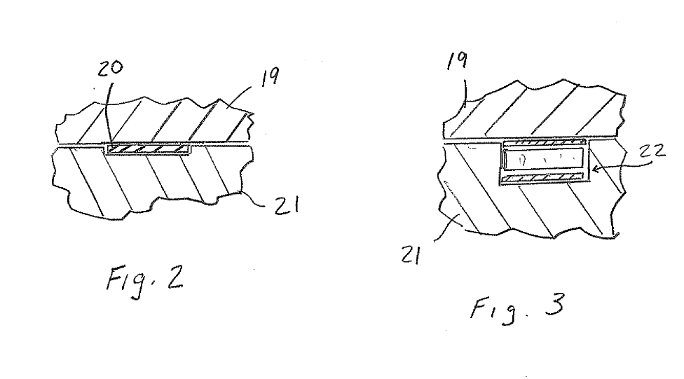

Bearings between the cutter cone 21 and bearing pin 19 can include friction bearings, such as a plain journal typically having treated surfaces, as well as antifriction bearings that include bearings having rolling members such as roller, needle, or ball bearings. The bearing pin 19 itself can provide a bearing surface, optionally; a friction or antifriction bearing can be attached or pressed onto the pin 19 or into a recess on the pin 19 outer surface. Similarly, the cone 21 surface that contacts the bearing pin 19 can be a bearing surface. Optionally, bearings can be attached or pressed in the cone 21. A side section view of bearing means is provided in FIG. 2, as shown, the bearing means comprises a journal 20 disposed in a recess formed in the cone 21. Optionally, the bearing means may comprise a roller bearing assembly 22, as shown in a side partial sectional view in FIG. 3. In the embodiments of either FIG. 2 or FIG. 3, the bearing means receives lubrication via a lubricant passage 27. Lubricant is injected into the bit 11 via a port (not shown) that communicates with the passage 27. A pressure compensator 29, shown in cross section disposed in the body 13, communicates downhole pressure to the lubricant passage 27. This equalizes lubricant pressure in the bit 11 with downhole pressure to minimize pressure differentials across the seal 33.

While the invention has been shown or described in only some of its forms, it should be apparent to those skilled in the art that it is not so limited, but is susceptible to various changes without departing from the scope of the invention.

What is claimed is:

1. An earth-boring bit comprising:
a bit body;
a cantilevered shaft depending from the bit body;
a conically shaped cutter rotatably mounted on the shaft;
bearing surfaces on the shaft and the conical cutter; and
a non-grease type lubricant comprising a synthetic fluid on the bearing surfaces.

2. The earth boring bit of claim 1, wherein the bearing is selected from the list consisting of friction bearings and antifriction bearings.

3. The earth boring bit of claim 1, wherein the synthetic fluid comprises a polyalphaolefin.

4. The earth boring bit of claim 1, wherein the synthetic fluid comprises a polyolester.

5. The earth boring bit of claim 1, wherein the synthetic fluid comprises a polyalkylene glycol.

6. The earth boring bit of claim 1, wherein the synthetic fluid comprises combinations of polyalphaolefin, polyolester, and polyalkylene glycols.

7. The earth boring bit of claim 1, wherein the synthetic fluid comprises a fluid selected from the list consisting of hydrocarbon fluids, esters, polyethers, alkylene oxide polymers, esters of phosphorus, silicon based fluid, fluorinated polyethers, and combinations thereof.

8. The earth boring bit of claim 1, wherein the lubricant comprises at least about 51% by volume of synthetic fluid.

9. The earth boring bit of claim 1, the lubricant further comprising a solid selected from the list consisting of molybdenum disulfide, tungsten disulfide, graphite, calcium fluoride, zinc oxide, and combinations thereof.

10. The earth boring bit of claim 1, wherein the lubricant viscosity is at least 100 centistokes at 212° F.

11. The earth boring bit of claim 1, wherein the lubricant is free of a thickening agent.

12. An earth-boring bit comprising:
a bit body;
a cantilevered shaft depending from the bit body;
a conically shaped cutter rotatably mounted on the shaft,
bearing surfaces formed on the shaft and the conical cutter; and
a synthetic fluid lubricant free of a thickening agent and having a viscosity of at least about 100 centistokes at 212° F.

13. The earth boring bit of claim 12, wherein the bearing surface is selected from the list consisting of a journal bearing surface and a roller bearing surface.

14. The earth boring bit of claim 12, wherein the synthetic fluid comprises a polyalphaolefin.

15. The earth boring bit of claim 12, wherein the lubricant comprises at least about 51% by volume of synthetic fluid.

16. The earth boring bit of claim 12, the lubricant further comprising a solid selected from the list consisting of molybdenum disulfide, tungsten disulfide, graphite, calcium fluoride, zinc oxide, and combinations thereof.

17. The earth boring bit of claim 12, wherein the lubricant comprises at least one of polyalphaolefin, polyolester, and polyalkylene glycols disposed on the bearing surface.

18. A method of lubricating an earth boring bit comprising:
providing a bit body; a cantilevered bearing shaft depending from the bit body, a conically shaped cutter rotatably mounted on the shaft, a bearing surface formed on the shaft, and a bearing surface formed on the conical cutter; and
adding to the bearing surface a non grease lubricant having a synthetic fluid.

19. The method of claim 18, further comprising providing the synthetic fluid from the list consisting of a polyalphaolefin, polyolester, polyalkylene glycol and combinations thereof.

20. The method of claim 18, further comprising providing a solid with the lubricant selected from the list molybdenum disulfide, tungsten disulfide, graphite, calcium fluoride, zinc oxide, and combinations thereof.

21. The earth boring bit of claim 14, wherein the lubricant viscosity is at least about 100 centistokes at 212° F.
